(19) United States
(12) Patent Application Publication
(10) Pub. No.: US 2006/0290212 A1
(43) Pub. Date: Dec. 28, 2006

(54) Linear actuator capable of easily linearly moving a movable portion with respect to a fixed portion

(75) Inventors: Hiromi Inoguchi, Kanagawa (JP); Masahiko Aranai, Tokyo (JP); Kazutaka Sakaguchi, Tokyo (JP); Kazuhiro Aoyama, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 11/477,187

(22) Filed: Jun. 28, 2006

(30) Foreign Application Priority Data
Jun. 28, 2005 (JP) 2005-188015

(51) Int. Cl. H02K 41/00; G11B 23/02

(52) U.S. Cl. 310/12; 360/132

(57) ABSTRACT

Upper and lower leaf springs linear-movably support a sub movable portion with respect to a sub fixed portion. Each of the upper and lower leaf springs has a substantially symmetrical shape, which is symmetric with respect to a center portion thereof, so as to be mounted on the sub fixed portion at the center portion and so as to be mounted on the sub movable portions at both end portions thereof. Each of the upper and lower leaf springs has at least one pair of bending portions, which is symmetric with respect to the center portion, between the center portion and the both end portions.

This application claims priority to Japanese Patent Application JP 2005-188015, the disclosure of which is incorporated herein by reference.

### BACKGROUND OF THE INVENTION

This invention relates to a recording and/or reproducing device represented by DLT (digital linear tape) or LTO (linear tape open) and, in particular, to an electromagnetic (a composite) liner actuator which can used as a head feed mechanism for moving a magnetic head used in the recording and/or reproducing device.

Recording and/or reproducing devices of the type described are developed for use in “back-up” systems for hard disks of computer systems and various types of the recording and/or reproducing devices have been proposed in prior art. Such a recording and/or reproducing device serving as the DLT is disclosed in U.S. Pat. No. 5,862,014 to Nute, entitled: “Multi-Channel Magnetic Tape Head Module Including Flex Circuit” or the like.

The recording and/or reproducing device (which may be merely called “driving apparatus”, “tape drive”, or “drive”) is for receiving a tape cartridge (which may be merely called “cartridge”) having a single reel (a supply reel) and contains a take-up reel therein. When the tape cartridge is installed in the driving apparatus, a magnetic tape is pulled out of the tape cartridge and then is wound by the take-up reel through a head guide assembly (HGA). The head guide assembly is for guiding the magnetic tape (which may be merely called “tape”) pulled out of the tape cartridge in a magnetic head. The magnetic head exchanges information between the tape and the magnetic head. The head guide assembly generally comprises a boomerang-shaped aluminum plate and six large guide rollers each using a bearing.

In addition, the head guide assembly is also called a tape guide assembly which is disclosed, for example, in U.S. Pat. No. 5,414,585 to Saliba, entitled: “Rotating Tape Edge Guide.” In addition, an example of the guide roller is disclosed in Japanese Unexamined Patent Application Publication Tokkai No. 2000-100025 or JP-A 2000-100025.

The magnetic tape drive is generally comprised a rectangular housing that has a common base as described, for example, in U.S. Pat. No. 5,793,574, entitled: “Tape Head Actuator Assembly Having A Shock Suppression Sleeve” to Cranson et al. The base has two spindle motors (reel motors). The first spindle motor has a spool (or a take-up reel) permanently mounted on the base and the spool is dimensioned to accept a relatively high streaming magnetic tape. The second spindle motor (reel motor) is adapted to accept a removable tape cartridge. The removable tape cartridge is manually or automatically inserted into the drive via a slot formed on the drive's housing. Upon insertion of the tape cartridge into the slot, the cartridge engages the second spindle motor (reel motor). Prior to rotation of the first and second spindle motors, the tape cartridge is connected to the permanently mounted spool (the take-up reel) by means of a mechanical buckling mechanism. A number of rollers (guide rollers) positioned intermediate the tape cartridge and the permanent spool guide the magnetic tape as it traverses at relatively high speeds back and forth between the tape cartridge and the permanently mounted spool.

In the digital linear tape drive having such a structure, an apparatus for pulling the tape from the supply reel to the take-up reel is required. Such as a pulling apparatus is disclosed, for example, in International Publication Number WO 86/07471. According to WO 86/07471, take up leader means (a first tape leader) is coupled to the take-up reel which supply tape leader means (a second tape leader) is connected to the tape on the supply reel. The first tape leader has one end formed into a mushroom like tab. The second tape leader has a locking aperture. The tab is engaged into the locking aperture.

Furthermore, a mechanism for joining the first tape leader with the second tape leader is required. Such a joining mechanism is disclosed, for example, in International Publication number WO 86/07295.

In addition, Japanese Unexamined Patent Application Publication Tokkai No. 2000-100116 or JP-A 2000-100116 discloses a structure of leader tape engaging part which can engage an end part of a leader tape (the second tape leader) to a tape end hooking part in a tape cartridge without requiring a tab projected in the side of the leader tape.

U.S. Pat. No. 5,857,634, entitled: “Take-up Reel Lock” to Hertrich discloses a locking system for preventing a take-up reel of a tape drive from rotating when a tape cartridge is not inserted to the drive.

In addition, the tape drive further comprises a magnetic head actuator assembly which is located between a take-up spool and a tape cartridge on a tape path defined by a plurality of rollers. During operation, a magnetic tape flows forward and backward between the take-up spool and the tape cartridge and is closely adjacent to the magnetic head actuator assembly while the magnetic tape flows on the defined tape path. An example of such as a magnetic head actuator assembly is disclosed in the above-mentioned U.S. Pat. No. 5,793,574.

On the other hand, an example of the tape cartridge installed in the digital leaner tape drive is disclosed in Japanese Unexamined Patent Application Publication Tokkai No. 2000-149291 or JP-A 2000-149491.

In addition, U.S. Pat. No. 6,241,171, entitled: “Leaderless Tape Drive” to Gaboury discloses a tape drive wherein a tape leader from a tape cartridge is urged through a tape path, into a take-up reel, and secured therein without the use of a bucking mechanism or take-up leader.

The magnetic head actuator assembly comprises a tape head assembly (which may be merely called “head assembly”) and a head feed mechanism. The head assembly comprises a magnetic head (head) extending up and down, a head holder for holding the magnetic head, and a pair of flexible printed circuits (FPCs) for electrically connecting the magnetic head with an external circuit.

On the other hand, the head feed mechanism is for moving the head assembly up and down in a widthwise direction of the magnetic tape with the head assembly held. A conventional head feed mechanism comprises a threaded shaft, i.e., a lead screw as disclosed in U.S. Pat. No. 5,793,574 mentioned above. By rotating the lead screw, the head assembly is mechanically linearly moved up and down. In other words, the conventional head feed mechanism comprises a “mechanical linear actuator.”

In the mechanical linear actuator, position control of the head assembly is carried out by so-called open-loop control. In the DLT, increases in storage capacity thereof have been planed. A “DLT1”, which is a first-generation DLT, has usual storage capacity of 40 gigabytes and compressed storage capacity of 80 gigabytes. In addition, a “DLT2”, which is a second-generation DLT, has usual storage capacity of 80 gigabytes and compressed storage capacity of 160 gigabytes. Furthermore, a “DLT3”, which is a third-generation DLT, has usual storage capacity of about 150 gigabytes and compressed storage capacity of about 300 gigabytes. In the DLTs having the storage capacity of the order of those, it is possible to sufficiently support by the mechanical linear actuator.

However, a “DLT4”, which is next-generation (fourth-generation) DLT, has usual storage capacity of 300 gigabytes and has compressed storage capacity of 600 gigabytes and has therefore a large storage capacity (high storage density). It is therefore difficult to accurately control the head assembly with a desired position when the above-mentioned mechanical linear actuator is used as the linear actuator for the DLT having the large storage capacity (the high storage density).

On the other hand, in order to resolve problems in such as mechanical linear actuator, a method of adopting, as the head feed mechanism, an “electromagnetic” linear actuator for electromagnetically making the head assembly up-and-down movements (linear movements) is proposed in, for example, Japanese Unexamined Patent Application Publication Tokkai No. 2002-233127 or JP-A2002-233127, In the electromagnetic linear actuator, position control of the head assembly is carried out by so called closed-loop (feedback) control. Inasmuch as the electromagnetic linear actuator adopts a feedback control system as a control system, it is possible to always control the head assembly so as to make a position thereof a desired position with high accuracy although the magnetic tape changes up and down on running.

Such an electromagnetic linear actuator generally comprises a fixed portion, a movable portion holding the head assembly (an elevated object) so that the head assembly is movably up and down with respect to the fixed portion, a guide for constraining (regulating) the movement of the movable portion except in moving (upward and downward) directions, and a base for mounting the guide thereon.

Herein, the electromagnetic linear actuators are classified into two types. A first type comprises an electromagnetic linear actuator of a “movable magnetic type” wherein the movable portion is provided with magnets and the fixed portion is provided with a coil. A second type comprises an electromagnetic linear actuator of a “movable coil type” wherein the fixed portion is provided with magnets and yokes and the movable portion is provided with a coil.

As described above, the electromagnetic linear actuator is suitable for the actuator for use in the DLT having the large storage capacity. However, in the manner which is described above, the mechanical linear actuator and the electromagnetic linear actuator have entirely different control systems (methods) to each other. It will be assumed that the electromagnetic linear actuator is used as the linear actuator for the low end DLTs (i.e. the first-generation DLT or the second generation DLT). In this event, inasmuch as it is impossible to entirely use the control system for the mechanical linear actuator which is installed therein to now, it is necessary to install a new control system suitable for the electromagnetic linear actuator. That is, it is necessary for the low-end DLTs to make engineering changes thereto.

In order to resolve such a problem, a composite linear actuator, which maintains compatibility with the low-end DLTs, as been proposed as the linear actuator (the head feed mechanism) for the fourth-generation DLT (the high-end DLT). The composite linear actuator serves not only as the mechanical linear actuator but also as the electromagnetic linear actuator. That is, the composite linear actuator is one where the electromagnetic linear actuator is integrated in the mechanical linear actuator. It is possible for the composite linear actuator to carry out a coarse position control (open loop control) of the head assembly by means of the mechanical linear actuator and to carry out a precise position control (closed loop control) of the head assembly by means of the electromagnetic linear actuator.

More specifically, the composite linear actuator includes the mechanical linear actuator which comprises a lead screw having a rotation center axis extending in an axial direction and a main movable portion for linearly moving along the axial direction by the rotation of the lead screw. The main movable portion serves as the electromagnetic linear actuator which comprises a sub fixed portion and a sub movable portion for linearly moving with respect to the sub fixed portion in the axial direction by an electromagnetic force. The electromagnetic linear actuator is composed of a voice coil motor (VCM). Therefore, the sub fixed portion is called a VCM fixed portion while the sub movable portion is called a VCM movable portion. The sub fixed portion is provided with yokes and magnets while the sub movable portion includes an air-core coil. The air-core coil is fixed to a head holder (mounting portion) for holding the magnetic head. Such a composite linear actuator is, for example, in Japanese Unexamined Patent Application Publications Tokkai No. 2004-86973 and 2004-87654 (or JP-A 2004-86973 and JP-A 2004-87654).

This invention relates to the composite linear actuator and, in particularly, to the electromagnetic linear actuator for use in the composite linear actuator. In the electromagnetic linear actuator, the sub movable portion is movably supported to the sub fixed portion via a supporting arrangement. Such a supporting arrangement comprises upper and lower leaf springs which linear-movably fix the sub movable portion to the sub fixed portion.

In the conventional recording and/or reproducing device, each of the upper and the lower leaf springs has a flat shape. It is necessary for the electromagnetic linear actuator to linearly move the sub movable portion with respect to the sub fixed portion. However, inasmuch as the leaf springs have the flat shape as described above, the leaf spring itself becomes to swing along an arc, as shown in FIG. 1, although it may bring the sub movable portion into operation so as to linearly move it with respect to the sub fixed portion. Accordingly, it is difficult to linearly move the leaf spring.

On the other hand, in order to linearly move the sub movable portion with respect to the sub fixed portion, it is necessary to make the leaf spring act a pulling force toward its longitudinal direction. In other words, the leaf spring has high spring-load.

In addition, another recording and/or reproducing device serving as the LTO is disclosed, for example, in U.S. Pat. No. 6,322,014 to Nemeth, entitled: “Recording and/or Reproducing Device Having A Tape Pull-out Element and A Coupling Element and Having Locking Means for Holding Together These Two Element.” The LTO uses a composite linear actuator which is similar in structure to that for use in the DLT. In the LTO, a serve track is preliminarily recorded in a magnetic recording surface side of the magnetic tape in parallel with data tracks and a position of the magnetic head is controlled so as to maintain at a correct position on the magnetic tape by reading the servo track by the magnetic head.

In the above-mentioned combined linear actuator, the mechanical linear actuator may be called the head feed mechanism while the electromagnetic linear actuator may be called a voice coil motor. That is, the head feed mechanism is for carrying out coarse adjustments of the position of the magnetic head by making the head assembly up-and-down movements while the voice coil motor is for carrying out fine adjustments of the position of the magnetic head.

### SUMMARY OF THE INVENTION

It is therefore an object of the present invention to provide an electromagnetic linear actuator which is capable of easily linearly moving a movable portion with respect to a fixed portion.

It is another object of the present invention to provide a composite linear actuator which is capable of easily linearly moving a sub movable portion with respect to a sub fixed portion.

Other objects of this invention will become clear as the description proceeds.

On describing the gist of a first aspect of this invention, it is possible to be understood that an electromagnetic linear actuator comprises a fixed portion comprising yokes and magnets, a movable portion which includes a coil and which linearly moves with respect to the fixed portion in an axial direction by an electromagnetic force, and upper and lower leaf springs for linear-movably supporting the movable portion with respect to the fixed portion. According to the first aspect of this invention, each of the upper and the lower leaf springs has a substantially symmetrical shape, which is symmetric with respect to the center portion, so as to be mounted on the fixed portion at a center portion thereof and so as to be mounted on the movable portion at both end portions thereof. Each of the upper and the lower leaf springs has at least one pair of bending portions, which are symmetric with respect to the center portion, between the center portion and the both end portions.

On describing the gist of a second aspect of this invention, it is possible to be understood that a composite liner actuator comprises a mechanical linear actuator and an electromagnetic linear actuator which is installed in the mechanical liner actuator. The mechanical linear actuator comprises a lead screw having a rotational center axis extending in an axial direction, and a main movable portion for linearly moving in the axial direction by rotation of the lead screw. The main movable portion acts as the electromagnetic linear actuator. The electromagnetic linear actuator comprises a sub fixed portion comprising yokes and magnets, a sub movable portion which includes a coil and which linearly moves in the axial direction with respect to the sub fixed portion by an electromagnetic force, and upper and lower leaf springs for linear-movably supporting the sub movable portions with respect to the sub fixed portion. According to the second aspect of this invention, each of the upper and the lower leaf springs has a substantially symmetrical shape, which is symmetric with respect to the center portion, so as to be mounted on the sub fixed portion at a center portion thereof and so as to be mounted on the sub movable portion at both end portions thereof. Each of the upper and the lower leaf springs has at least one pair of bending portions, which are symmetric with respect to the center portion, between the center portion and the both end portions.

In the above-mentioned electromagnetic linear actuator (composite linear actuator), when a distance between the both end portions is equal to L, the pair of bending portions preferably may be disposed at positions which are apart from said center portion by L/4. In addition, each of the upper and the lower leaf springs may have a thickness t which lies in a range between 0.08 mm and 0.1 mm, each of the pair of bending portions desirably may have a height which lies in a range between 8t and 12t. Furthermore, each of the pair of bending portions preferably may have an included angle which lies in a range of 80 degrees and 90 degrees. Each of the upper and the lower bending portions desirably may have at least one pair of openings which are symmetric with respect to the center portion.

### BRIEF DESCRIPTION OF THE DRAWINGS

FIG. 1 is a view for use in describing a deformed direction and a direction of force of a conventional leaf spring used in a composite linear actuator of a conventional recording and/or reproducing device;

FIG. 2 is a view for use in describing the deformed direction and the direction of force of the conventional leaf spring in a case of linearly moving the conventional leaf spring;

FIG. 3 is a perspective view showing a tape drive serving as a recording and/or reproducing device to which this invention is applicable with an upper cover removed therefrom seen from an upper surface thereof;

FIG. 4 is a perspective view showing the tape drive illustrated in FIG. 3 seen from a lower surface thereof;

FIG. 5 is a perspective view showing an outer experience of an electromagnetic linear actuator in a composite linear actuator according to an embodiment of this invention that is used in the tape drive illustrated in FIG. 3;

FIG. 6 is an exploded perspective view of the electromagnetic linear actuator illustrated in FIG. 5;

FIG. 7 is a perspective view showing an upper leaf spring used in the electromagnetic linear actuator illustrated in FIG. 5;

FIG. 8 is a perspective view showing a conventional upper leaf spring;

FIG. 9 is a view for use in describing a deformed direction and a direction of force of the upper leaf spring illustrated in FIG. 7; and

FIG. 10 is a cross-sectional view of the upper leaf spring illustrated in FIG. 7.

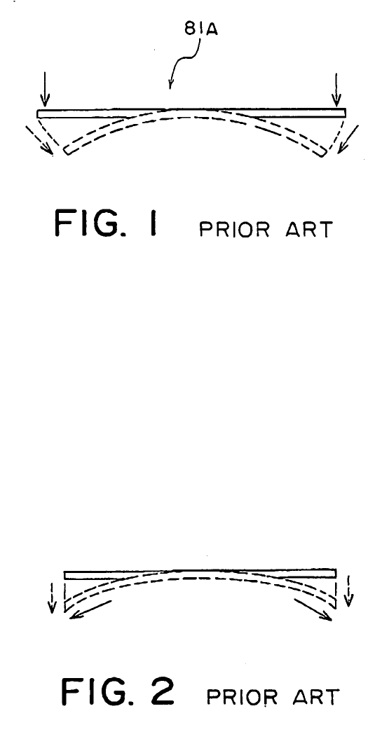

### DESCRIPTION OF THE PREFERRED EMBODIMENT

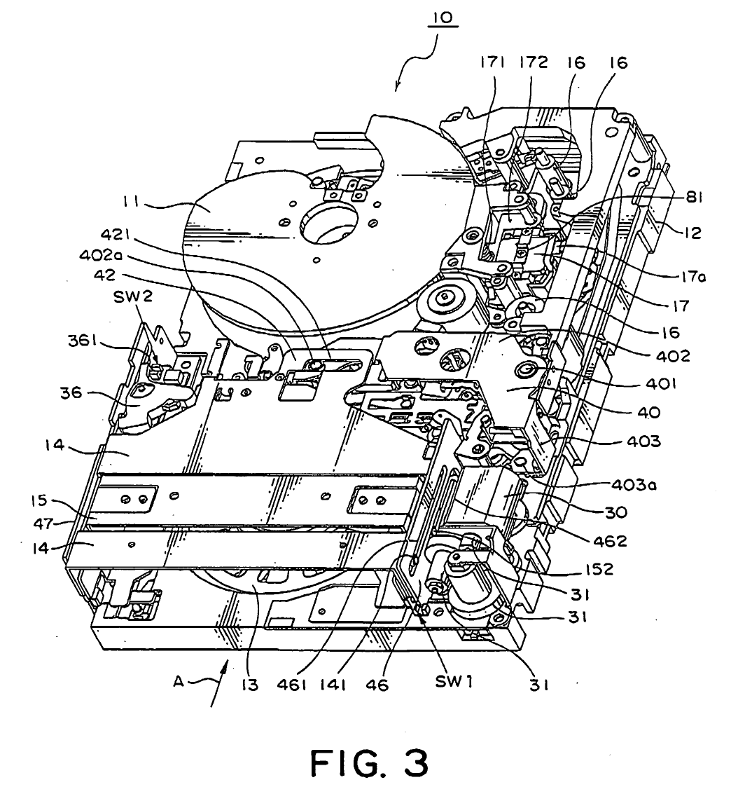

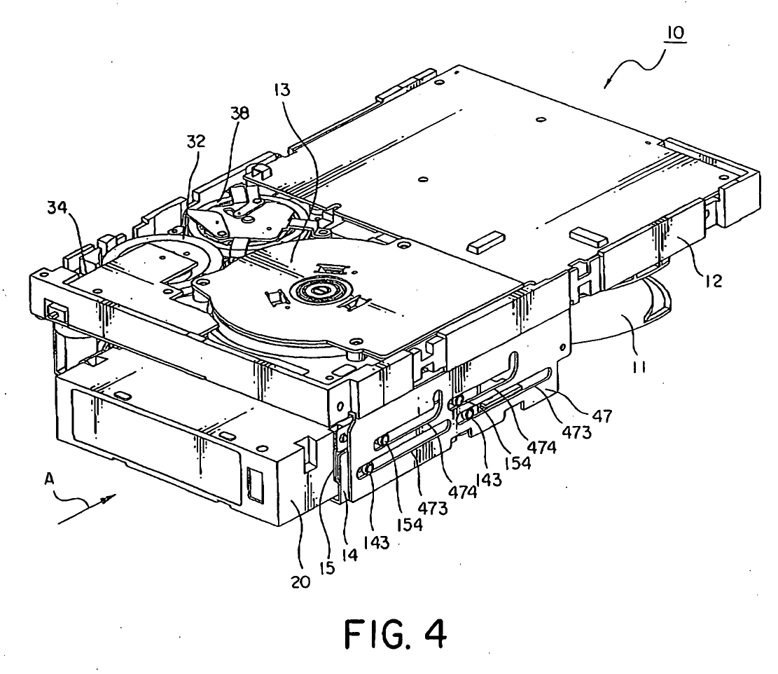

Referring to FIGS. 3 and 4, the description will proceed to a tape drive 10 serving as a recording and/or reproducing device to which this invention is applicable. FIG. 3 is a perspective view showing the tape drive 10 with an upper cover removed therefrom seen from an upper surface side. FIG. 4 is a perspective view showing the tape drive 10 illustrated in FIG. 3 seen from a lower surface side.

The tape drive 10 is for receiving a cartridge 20 and contains a take-up reel 11 inside thereof. The take-up reel 11 is also called a spool. The tape drive 10 is generally comprised of a rectangular housing (chassis) 12 that has a common base. The base has a first spindle motor (reel motor) (not shown) and a second spindle motor (reel motor) 13. The first spindle motor has the spool (or the take-up reel) 11 permanently mounted on the base of the housing 12 and the spool 11 is dimensioned to accept a relatively high speed streaming magnetic tape (which will later be described). The second spindle motor (reel motor) 13 is adapted to accept the removable cartridge 20. The removable cartridge 20 is inserted into the tape drive 10 via a cartridge holder 14 formed on the housing 12 of the tape drive 10 along an insertion direction depicted at an arrow A.

Upon insertion of the cartridge 20 into the cartridge holder 14, the cartridge 20 first is engaged in a cartridge holding mechanism 15, is automatically loaded in the tape drive 10, and then the cartridge 20 engages the second spindle motor (the supply reel motor) 13. Prior to rotation of the first and the second spindle motors (reel motors), the cartridge 20 is connected to the permanently mounted spool (the take-up reel) 11 by means of a connection between a grabber (not shown) and a leader pin (not shown). A number of rollers (guide rollers) 16 positioned intermediate the cartridge 20 and the permanent spool 11 guide the magnetic tape as it traverses at relatively high speeds back and forth between the cartridge 20 and the permanently mounted spool 11.

The tape drive 10 further comprises a head actuator assembly 17 having a magnetic head 17a. The head actuator 17 is located between the take-up spool 11 and the cartridge 20 on a tape-transport path (not shown) defined by the above-mentioned plurality of rollers 16. During operation, the magnetic tape flows forward and backward between the take-up spool 11 and the cartridge 20 and is closely adjacent to the head actuator 17 while the magnetic tape flows on the defined tape-transport path.

The tape drive 10 has a first switch SW1 provided on a main surface of the chassis 12 at a front and right-hand side thereof. The first switch SW1 is for detecting a position at which an automatic loading starts after the cartridge 20 is inserted in the cartridge holder 14. The first switch SW1 comprises a photo-interrupter. The cartridge holder 14 comprises a first shielding plate (not shown) for shielding the first switch SW1.

The tape drive 10 comprises a mode motor 30 mounted on the main surface of the chassis 12. The mode motor 30 is coupled via seven reduction gears 31 (only three reduction gears are illustrated in FIG. 3) to a mode gear 32 provided in a rear surface side of the chassis 12. In the rear surface side of the chassis 12, a sensor board 34 is provided opposite to the mode gear 32. At any rate, the mode gear 32 is driven by the mode motor 30.

As shown in FIG. 3, the tape drive 10 has a second switch SW2 for detecting that the cartridge 20 is correctly accommodated (or inserted) in the cartridge holder 14. The second switch SW4 also comprises a photo-interrupter. The tape drive 10 comprises a cartridge holder locking mechanism 36 for locking the cartridge holder 14. The cartridge holder locking mechanism 36 is for preventing the cartridge holder 14 from moving in the insertion direction A when the cartridge 20 is not correctly inserted in the cartridge holder 14. Accordingly, when the cartridge 20 is correctly inserted in the cartridge holder 14, a lock of the cartridge holder 14 by the cartridge holder locking mechanism 36 is released and it results in allowing the cartridge holder 14 to move in the insertion direction A. The cartridge holder locking mechanism 36 comprises a second shielding plate 361 for shielding the second switch SW2.

As shown in FIG. 4, the tape drive 10 comprises a gear cam 38 engaged with the mode gear 32. The gear cam 38 is also called a cam gear. The gear cam 38 has a cam groove (not shown).

As shown in FIG. 3, the tape drive 10 comprises an arm housing 40 which is rotatably disposed on the main surface of the chassis 12 around a rotation shaft 401. The arm housing 40 comprises a horizontal arm 402 extending in a horizontal direction and a vertical arm 403 extending in a vertical direction. The horizontal arm 402 has a tip in which an engagement pin 402a is provided. The vertical arm 403 has a lower end in which an engagement pin 403a is provided. The engagement pin 403a engages with the above-mentioned cam groove of the gear cam 38.

In addition, the tape drive 10 comprises a cam slider 42 which is integrally formed to the cartridge holder 14. The cam slider 42 has a slider slit 421 extending in a direction perpendicular to the insertion direction A. In the slider slit 421, the engagement pin 402a of the horizontal arm 402 of the above mentioned arm housing 40 is inserted.

Accordingly, the cartridge holder 14 for holding the cartridge 20 is coupled to the mode gear 32 through the cam slider 42, the arm housing 40, and the gear cam 38. A combination of the mode motor 30, the mode gear 32, and the cartridge holder 14 serves as the ejection mechanism for ejecting the cartridge 20 accommodated in the tape drive 10 out of the tape drive 10 by coming into contact with the cartridge 20.

When the cartridge 20 is inserted in the cartridge holder 14, the cartridge 20 is held in the cartridge holder 14 through the cartridge holding mechanism 15. When the cartridge 20 is perfectly held in the cartridge holder 14, the cartridge 20 is engaged with the cartridge holding mechanism 15.

In addition, the cartridge holder 14 is only movable along the insertion direction A by a guide arrangement which will later be described. The cartridge holding mechanism 15 is movable along an L-shaped pass of movement by the guide arrangement.

With this structure, when the cartridge holder 14 moves in the insertion direction A by manually inserting the cartridge 20 in the cartridge holder 14, the arm housing 40 rotates around the rotation shaft 401 in a clockwise direction. As a result, inasmuch as the gear cam 38 rotates around a center axis thereof, the mode gear 32 engaged with the gear cam 38 also rotates around a center axis thereof. This operation is a manual load operation.

On the other hand, the mode gear 32 and the mode motor 30 are coupled to each other via the seven reduction gears 31. Accordingly, if the mode motor 30 rotates in a predetermined direction, the mode gear 32 rotates in the predetermined direction. Therefore, engaged with the mode gear 32, the cam gear 38 also rotates in the predetermined direction. As a result, the arm housing 40 having the engagement pin 403a, which is engaged with the cam groove of the gear cam 38, rotates around the rotation shaft 401 in the clockwise direction. Therefore, when the cartridge holder 14 moves in the insertion direction A, engaged with the cartridge holding mechanism 15, the cartridge 20 also moves in the insertion direction A. This operation is an automatic load operation.

A switching between the manual load operation and the automatic load operation is carried out by turning on/off of the first switch SW1.

Referring now to FIGS. 3 and 4, the description will proceed to the guide arrangement for guiding the cartridge holder 14 and the cartridge holding mechanism 15.

The tape drive 10 comprises, as the guide arrangement, a first guide wall 46 and a second guide wall 47 both of which extend in the insertion direction A. The first guide wall 46 is called a right-hand guide wall because it is disposed in a right hand with respect to the insertion direction A. The second guide wall 47 is called a left-hand guide wall because it is disposed in a left hand with respect to the insertion direction A.

As shown in FIG. 3, the first guide wall (the right-hand guide wall) 46 has a first guide channel slot 461 for guiding the cartridge holder 14 and a second guide channel slot 462 for guiding the cartridge holding mechanism 15. The first guide channel slot 461 extends along the insertion direction A. On the other hand, the second guide channel slot 462 has an L-shape which extends along the insertion direction A and extends in a direction perpendicular to the insertion direction A toward the chassis 12. In the first guide channel slot 461, a first guide pin 141 is engaged. The first guide pin 141 projects laterally from a right-hand wall of the cartridge holder 14. In the second guide channel slot 462, a second guide pin 152 is engaged. The second guide pin 152 projects laterally from a right-hand wall of the cartridge holding mechanism 15.

As shown in FIG. 4, the second guide wall (the left-hand guide wall) 47 has a pair of third guide channel slots 473 for guiding the cartridge holder 14 and a pair of fourth guide channel slots 474 for guiding the cartridge holding mechanism 15. The pair of third guide channel slots 473 extends along the insertion direction A. On the other hand, the pair of fourth guide channel slots 474 has an L-shape which extends along the insertion direction A and extends in a direction perpendicular to the insertion direction A toward the chassis 12. In the pair of third guide channel slots 473, a pair of third guide pins 143 is engaged, respectively. The pair of third guide pins 143 projects laterally from a left-hand wall of the cartridge holder 14. In the pair of fourth guide channel slots 474, a pair of fourth guide pins 154 is engaged, respectively. The pair of fourth guide pins 154 projects laterally from a left-hand wall of the cartridge holding mechanism 15.

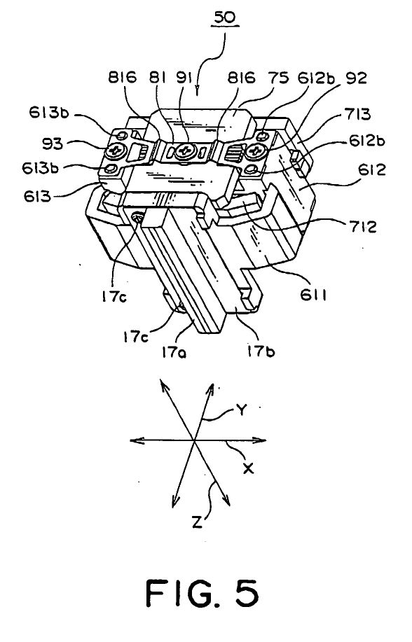

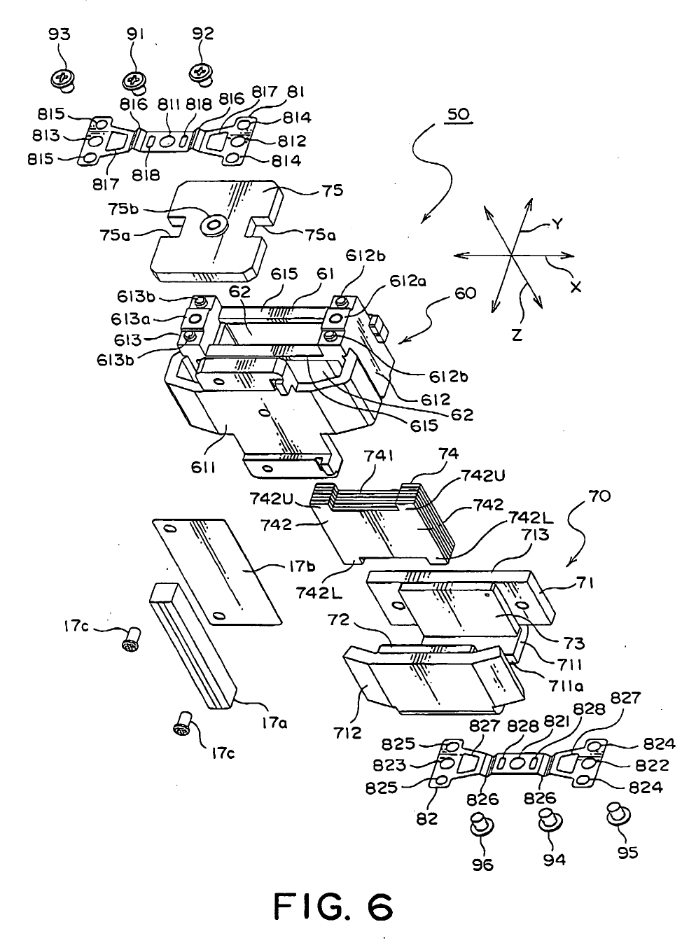

Referring now FIGS. 5 and 6 in addition to FIG. 3, the description will proceed to the head actuator 17 according to an embodiment of this invention. The illustrated head actuator 17 comprises a composite linear actuator. In the manner which is described above, the composite linear actuator 17 comprises a mechanical linear actuator (which will presently be described) and an electromagnetic linear actuator 50 installed in the mechanical linear actuator. FIG. 5 is a perspective view showing an outward appearance of the electromagnetic linear actuator 50 in the composite linear actuator. FIG. 6 is an exploded perspective view of the electromagnetic linear actuator.

As shown in FIG. 3, the head actuator 17 comprises, as a rotational portion, a lead screw 171 with a thread ridge (a threaded shaft) having a rotation center axis extending up and down (in an axial direction), and, as linearly moving portion, a lift 172 for making up-and-down movements along the rotation center axis following rotation of the lead screw 171. The lead screw is provided with, at lower end side thereof, a lead screw gear (not shown) for rotating the lead screw 171 around the rotation center axis by means of another driving arrangement (for example, a stepping motor). On the lift 171, the electromagnetic linear actuator 50 (which will later be described) is mounted. The lift 172 and the electromagnetic linear actuator 50 constitute a main movable portion. At any rate, a combination of the lead screw 171 and the main movable portion constitutes the mechanical linear actuator.

Referring to FIGS. 5 and 6, the description will proceed to the electromagnetic linear actuator 50. As illustrated in FIGS. 5 and 6, rectangular coordinate axes are represented by X-axis, Y-axis, and Z-axis. Herein, a direction of the X-axis is leftward and rightward, a direction of the Y-axis is backward and forward, and a direction of the Z-axis is upward and downward (the axial direction or a vertical direction).

The illustrated electromagnetic linear actuator 50 is for making the magnetic head 17a acting as an elevated object up-and-down movements along the vertical direction Z. The magnetic head 17a extends up and down (in the vertical direction Z). The magnetic head 17a is held by a head holder 17b. The magnetic head 17a and the head holder 17b constitute the head assembly. The head holder 17b is mounted, by means of two screws 17c, on a sub movable portion 60 which will later be described.

The magnetic head 17a is electrically connected to an external circuit (not shown) through a pair of flexible printed circuits (FPCs) which is not shown. In addition, a MR (magneto-resistive) head is used as the magnetic head 17a. The MR head is a device which is week resistance to static electricity because it is very sensitive in static electricity. Accordingly, it is necessary to be careful with handling the MR head.

The electromagnetic linear actuator 50 comprises a sub fixed portion 70, the sub fixed portion 60 for up-and-down movably holding the head assembly with respect to the sub fixed portion 70 along the vertical direction Z, and upper and lower leaf springs 81 and 82 for linear-movably supporting the sub movable portion 60 with respect to the sub fixed portion 70.

The sub fixed portion 70 comprises a yoke base 71, a pair of plate-shaped magnets 72 and 73 received in the yoke base 71, a center yoke 74, and an upper yoke 75. The yoke base 71 has a U shape in cross section and comprises a bottom yoke 711, a front wall yoke 712 for extending from a front end of the bottom yoke 711 upward, and a rear wall yoke 713 for extending from a rear end of the bottom yoke 711 upward. That is, the front wall yoke 712 and the rear wall yoke 713 are opposed to each other disposed with apart from each other. One magnet 72 is mounted on the front yoke 712 while another magnet 73 is mounted on the rear yoke 713. Between the front wall yoke 712 and the rear wall yoke 713, the center yoke 74 stands up from a enter portion of the bottom yoke 711.

More specifically, the center yoke 74 comprises a center portion 741 and a pair of side portions 742 at both laterally sides of the center portion 741. The pair of side portions 742 has a height longer than a length (a height) of the center portion 741 up and down. In other words, the pair of side portions 742 has lower projection portions 742L for projecting from a lower end of the center portion 741 downward and upper projection portions 742U for projecting from an upper end of the center portion 741 upward.

The bottom yoke 711 has a pair of bottom notch portions 711 a into which the lower projection portions 742L are fitted. Likewise, the upper yoke 75 has a pair of upper notch portions 75a into which the upper projection portions 742U are fitted. The upper yoke 75 covers the yoke base 71 and the center yoke 74 at an upper portion. The Illustrated center yoke 74 is made of a laminated steel sheet where a plurality of iron plates are laminated.

On the other hand, the sub movable portion 60 comprises a carriage 61 for moving the head assembly (the magnetic head 17a) in the vertical direction with holding the head assembly (the magnetic head 17a) and a coil 62 accommodated in the carriage 61. The coil 62 comprises an air-core coil which is wound around the center yoke 74 with a space therebetween.

More specifically, the carriage 61 comprises a front frame 611 disposed near the front wall yoke 712 forward, a right-hand frame 612 extending from a right end of the front frame 611 rearward, a left-hand frame 613 extending from a left end of the front frame 611 rearward, a lower bridge portion (not shown) for bridging between the right-hand frame 612 and the left-hand frame 613 at lower ends thereof, and an upper bridge portion 615 for bridging between the right-hand frame 612 and the left-hand frame 613 at upper ends thereof. The head holder 17b of the head assembly is mounted on the front frame 611.

The coil 62 is mounted on the lower bridge portion. In other words, the coil 62 is accommodated in a space enclosed among the lower bridge portion, the upper bridge portion 615, the right-hand frame 612, and the left-hand frame 613.

The upper yoke 75 has a spring mounting portion 75b with a screw hole for mounting a center portion of the upper leaf spring 81 at a center portion thereof. Although illustration is omitted, the bottom yoke 711 has a spring mounting portion with a screw hole for mounting a center portion of the lower leaf spring 82 at a center portion thereof.

The right-hand frame 612 has a spring mounting portion 612a with a screw hole for mounting a right end portion of the upper leaf spring 81 at a center of an upper end portion thereof, and a pair of bosses 612b for positioning the right end portion of the upper leaf spring 81 at fore-and-aft both ends of the upper portion thereof. Similarly, the left-hand frame 613 has a spring mounting portion 613a with a screw hole for mounting a left end portion of the upper leaf spring 81 at a center of an upper end portion thereof, and a pair of bosses 613b for positioning the left end portion of the upper leaf spring 81 at fore-and-aft both ends of the upper portion thereof.

Likewise, the right-hand frame 612 has a spring mounting portion (not shown) with a screw hole for mounting a right end portion of the lower leaf spring 82 at a center of a lower end portion thereof, and a pair of bosses (not shown) for positioning the right end portion of the lower leaf spring 82 at fore-and-aft both ends of the lower portion thereof. Similarly, the left-hand frame 613 has a spring mounting portion (not shown) with a screw hole for mounting a left end portion of the lower leaf spring 82 at a center of a lower end portion thereof, and a pair of bosses (not shown) for positioning the left end portion of the lower leaf spring 82 at fore-and-aft both ends of the upper portion thereof.

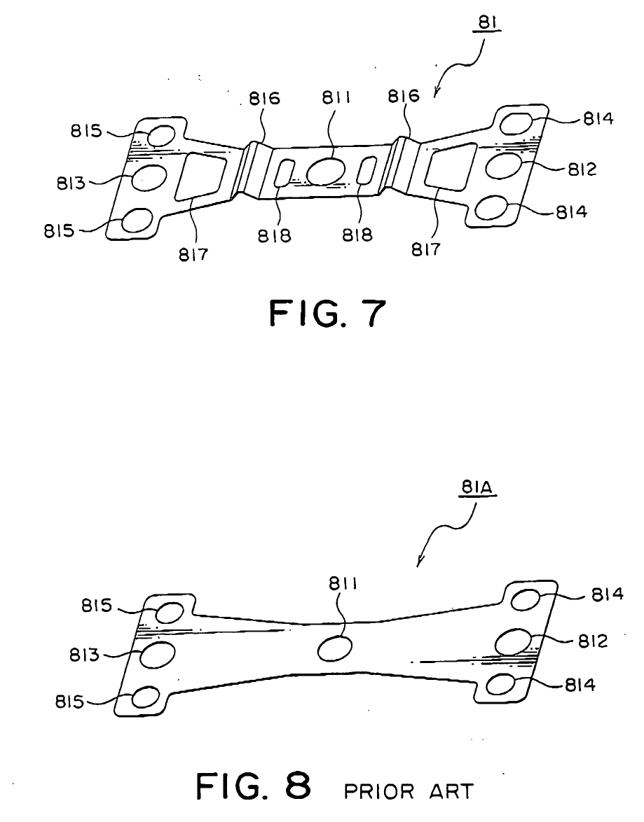

FIG. 7 is an enlarged perspective view of the upper leaf spring 81. In addition, inasmuch as the lower leaf spring 82 is similar in structure to the upper leaf spring 81, illustration thereof is omitted.

Referring to FIG. 7 in addition to FIG. 6, the upper leaf spring 81 has a center though hole 811 in which a first screw 91 penetrates at a center portion thereof, a right-hand through hole 812 in which a second screw 812 penetrates at a center of a right end portion thereof, and a left-hand through hole 813 in which a third screw 813 penetrates at a center of a left end portion thereof. In addition, the upper leaf spring 81 has a pair of right-hand positioning holes 814 into which the pair of bosses 612b formed on the upper end portion of the right-hand frame 612 is fitted at fore-and-aft both ends of the right end portion thereof, and a pair of left-hand positioning holes 815 into which the pair of bosses 613b formed on the upper portion of the left-hand frame 613 is fitted at fore-and-aft both ends of the left end portion thereof.

The upper leaf spring 81 has a pair of bending portions 816 for projecting upwards between the center through hole 811 and the right-hand through hole 812 and between the center through hole 811 and the left-hand through hole 813. That is, the upper leaf spring 81 has the pair of bending portions 816, which is symmetric with respect to the center portion, between the center portion and the both end portions. In addition, the upper leaf spring 81 has a pair of openings 817 wherein one is disposed between the bending portion 816 of the right side and the right-hand through hole 812 and another is disposed between the bending portion 816 of the left side and the left-hand through hole 813. The upper leaf spring 81 has a pair of another openings 818 disposed between the center through hole 811 and the bending portions 816 of both sides thereof.

For reference purposes, FIG. 8 shows a conventional upper leaf spring 81A. The conventional upper leaf spring 81A does not have the pair of bending portions 812 and has a substantially flat shape. In addition, the conventional upper leaf spring 81A does not have the openings 817 and 818 which are provided in the upper leaf spring 81 illustrated in FIG. 7.

In the upper leaf spring 81 having such a structure, the center portion thereof is mounted on the upper yoke 75 through the center through hole 811 by means of the first screw 91, the right end portion thereof is mounted on the upper end portion of the right-hand frame 612 through the right-hand through hole 812 by means of the second screw 92, and the left end portion thereof is mounted on the upper end portion of the left-hand frame 613 through the left-hand through hole 813 by means of the third screw 93.

At any rate, the upper leaf spring 81 has a substantially symmetrical shape which is symmetric with respect to the center portion wherein the upper leaf spring 81 is mounted on the sub fixed portion 70 at the center portion thereof and the upper leaf spring 81 is mounted on the sub movable portion 60 at the both end portion thereof.

Likewise, the lower leaf spring 82 has a center though hole 821 in which a fourth screw 94 penetrates at a center portion thereof, a right-hand through hole 822 in which a fifth screw 815 penetrates at a center of a right end portion thereof, and a left-hand through hole 823 in which a sixth screw 816 penetrates at a center of a left end portion thereof. In addition, the lower leaf spring 82 has a pair of right-hand positioning holes 824 into which the pair of bosses formed on the lower end portion of the right-hand frame 612 is fitted at fore-and-aft both ends of the right end portion thereof, and a pair of left-hand positioning holes 825 into which the pair of bosses formed on the lower portion of the left-hand frame 613 is fitted at fore-and-aft both ends of the left end portion thereof.

The lower leaf spring 82 has a pair of bending portions 826 for projecting downwards between the center through hole 821 and the right-hand through hole 822 and between the center through hole 821 and the left-hand through hole 823. That is, the lower leaf spring 82 has the pair of bending portions 826, which is symmetric with respect to the center portion, between the center portion and the both end portions. In addition, the upper leaf spring 82 has a pair of openings 827 wherein one is disposed between the bending portion 826 of the right side and the right-hand through hole 822 and another is disposed between the bending portion 826 of the left side and the left-hand through hole 823. The lower leaf spring 82 has a pair of another openings 828 disposed between the center through hole 821 and the bending portions 826 of both sides thereof.

In the lower leaf spring 82 having such a structure, the center portion thereof is mounted on the bottom yoke 711 through the center through hole 821 by means of the fourth screw 94, the right end portion thereof is mounted on the lower end portion of the right-hand frame 612 through the right-hand through hole 822 by means of the fifth screw 95, and the left end portion thereof is mounted on the lower end portion of the left-hand frame 613 through the left-hand through hole 823 by means of the sixth screw 96.

At any rate, the lower leaf spring 82 also has a substantially symmetrical shape which is symmetric with respect to the center portion wherein the lower leaf spring 82 is mounted on the sub fixed portion 70 at the center portion thereof and the lower leaf spring 82 is mounted on the sub movable portion 60 at the both end portion thereof.

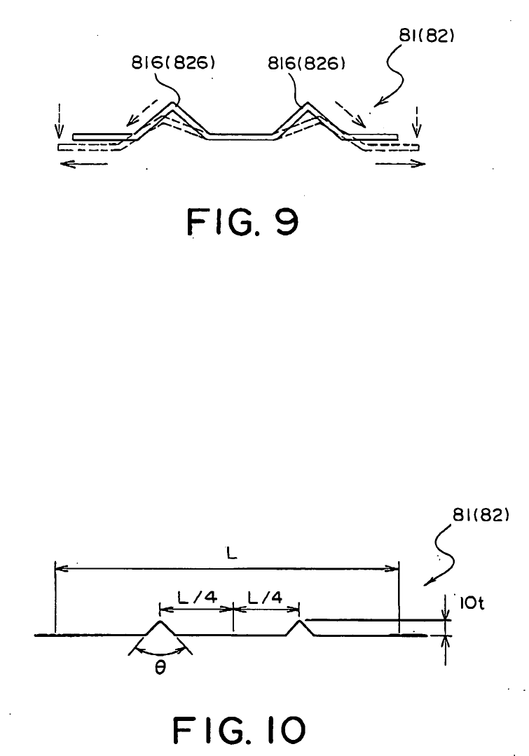

Inasmuch as the pair of bending portions 816 and 826 are added to the upper and the lower leaf springs 81 and 82, respectively, in the manner which is described above, the sub movable portion 60 easily moves on moving the sub movable portion 60 of the electromagnetic linear actuator 50. This is because, as illustrated in FIG. 9, the pair of bending portions 816 and 826 increase flexibility in the literal direction (the direction of the X-axis) and it results in decreasing spring-load in each of the upper leaf spring 81 and the lower leaf spring 82.

FIG. 10 shows a cross section of the upper leaf spring 81 (the lower leaf spring 82). As shown in FIG. 10, it will be assumed that a distance between the holes where the upper leaf spring 81 (the lower leaf spring 82) is fixed to the right-hand frame 612 and the left-hand frame 613 is equal to L. In this event, the pair of bending portions 816 (826) is added to the upper leaf spring 81 (the lower leaf spring 82) at a position of U4 from a center (the center portion). In addition, it will be presumed that the upper leaf spring 81 (the lower leaf spring 82) has a thickness of t. In this event, each bending portion 816 (826) has a height of 10t. In addition, it is desirable that the thickness t of the leaf spring 81 (82) lies in a range between 0.08 mm and 0.1 mm. This is because, if the thickness t of the leaf spring is thicker than 0.1 mm, the leaf spring has a high spring constant and it is disadvantageous in that resonance becomes high and may come to a used region when the movable portion of the actuator has a lightweight. On the other hand, if the thickness t of the leaf spring is thinner than 0.08 mm, it is disadvantageous in that distribution in market is bad, it is difficult to handle it, and so on. In addition, it is desirable that the height of each bending portion 816 (826) lies In a range between 8t and 12t. This is because, if the height of each bending portion 816 (826) is lower than 8t, the flexibility with respect to the lateral direction becomes low. If the height of each bending portion 816 (826) is higher than 12t, the upper leaf spring 81 (the lower leaf spring 82) becomes rigid. Furthermore, it is preferable that an included angle θ of each bending portion 816 (826) lies in a range between 80 degrees and 90 degrees. This is because, if the included angle θ of each bending portion 816 (826) is wider than 90 degrees, the flexibility in the lateral direction becomes low. If the included angle θ of each bending portion 816 (826) is narrower than 80 degrees, stress concentration occurs and a punch die for use in forming the bending portions 816 (826) has a short life.

Although the upper leaf spring 81 (the lower leaf spring 82) is provided with the openings 817 and 818 (827 and 828) in this embodiment, those openings are not always required and only the pair of bending portions 816 (826) may be added. The co-inventors checked that it is possible for the upper leaf spring (the lower leaf spring) where only the pair of bending portions 816 ((26) is added to decrease the spring constant by 40% from 0.25 kgf/mm to 0.15 kgf/mm in comparison with the conventional upper leaf spring 81A (lower leaf spring 82A).

By providing the openings 817 and 818 (827 and 828) to the upper leaf spring 81 (the lower leaf spring 82) in the manner of this embodiment, it is possible to further decrease the spring constant and to disperse stress.

At any rate, by up-and-down movably supporting the sub movable portion 60 to the sub fixed portion 70 via the upper and the lower leaf springs 81 and 82, it is possible to easily linearly move the sub movable portion 60 of the electromagnetic linear actuator 50.

While this invention has thus far been described in conjunction with a preferred embodiment thereof, it is to be understood that modifications will be apparent to those skilled in the art without departing from the spirit of the invention. For example, although the upper and lower leaf springs 81 and 82 are provided with only one pair of bending portions 816 and 826 in the above-mentioned embodiment, two or more pairs of bending portions may be provided. Although description is made about an example where the composite linear actuator is adapted as the magnetic head actuator assembly in the above-mentioned embodiment, it is obvious that this invention is applicable to the electromagnetic linear actuator in the similar manner.

What is claimed is:

1. An electromagnetic linear actuator comprising:
a fixed portion comprising yokes and magnets;
a movable portion including a coil, said movable portion linearly moving with respect to said fixed portion in an axial direction by an electromagnetic force; and
upper and lower leaf springs for linear-movably supporting said movable portion with respect to said fixed portion,
wherein each of said upper and said lower leaf springs has a substantially symmetrical shape, which is symmetric with respect to said center portion, so as to be mounted on said fixed portion at a center portion thereof and so as to be mounted on said movable portion at both end portions thereof, each of said upper and said lower leaf springs having at least one pair of bending portions, which are symmetric with respect to said center portion, between said center portion and said both end portions.

2. The electromagnetic linear actuator as claimed in claim 1, wherein a distance between said both end portions is equal to L, said pair of bending portions is disposed at positions which are apart from said center portion by U4.

3. The electromagnetic linear actuator as claimed in claim 1, wherein each of said upper and said lower leaf springs has a thickness t which lies in a range between 0.08 mm and 0.1 mm, each of said pair of bending portions has a height which lies in a range between 8t and 12t.

4. The electromagnetic linear actuator as claimed in claim 1, wherein each of said pair of bending portions has an included angle which lies in a range of 80 degrees and 90 degrees.

5. The electromagnetic linear actuator as claimed in claim 1, wherein each of said upper and said lower bending portions has at least one pair of openings which are symmetric with respect to said center portion.

6. A composite liner actuator comprising a mechanical linear actuator and an electromagnetic linear actuator which is installed in said mechanical liner actuator, wherein said mechanical linear actuator comprises:
a lead screw having a rotational center axis extending in an axial direction; and
a main movable portion for linearly moving in said axial direction by rotation of said lead screw, said main movable portion acting as said electromagnetic linear actuator,
wherein said electromagnetic linear actuator comprising:
a sub fixed portion comprising yokes and magnets;
a sub movable portion including a coil, said sub movable linearly moving in said axial direction with respect to said sub fixed portion by an electromagnetic force; and
upper and lower leaf springs for linear-movably supporting said sub movable portions with respect to said sub fixed portion,
wherein each of said upper and said lower leaf springs has a substantially symmetrical shape, which is symmetric with respect to said center portion, so as to be mounted on said sub fixed portion at a center portion thereof and so as to be mounted on the sub movable portion at both end portions thereof, each of said upper and said lower leaf springs having at least one pair of bending portions, which are symmetric with respect to said center portion, between said center portion and said both end portions.

7. The composite linear actuator as claimed in claim 6, wherein a distance of said both end portions is equal to L, said pair of bending portions is disposed at positions which are apart from said center portion by L/4.

8. The composite linear actuator as claimed in claim 6, wherein each of said upper and said lower leaf springs has a thickness t which lies in a range between 0.08 mm and 0.1 mm, each of said pair of bending portions has a height which lies in a range between 8t and 12t.

9. The composite linear actuator as claimed in claim 6, wherein each of said pair of bending portions has an included angle which lies in a range of 80 degrees and 90 degrees.

10. The composite linear actuator as claimed in claim 6, wherein each of said upper and said lower bending portions has at least one pair of openings which are symmetric with respect to said center portion.
